(19) United States
(12) Patent Application Publication
(10) Pub. No.: US 2008/0139378 A1
(43) Pub. Date: Jun. 12, 2008

(54) Urine-absorbing composition with fragrance release upon use

(75) Inventors: Jens Hildebrand, Aschaffenburg (DE); David Del Guercio, Chesterfield, VA (US); Hans-Jurgen Kohle, Mainhaussen (DE); Georg Schick, Chester, VA (US); Harald Jakob, Hasselroth (DE)

Correspondence Address: LAW OFFICE OF MICHAEL A. SANZO, LLC, 15400 CALHOUN DR., SUITE 125, ROCKVILLE, MD, 20855, US

(73) Assignee: Degussa AG, Dusseldorf (DE)

(21) Appl. No.: 11/634,898

(22) Filed: Dec. 7, 2006

(51) Int. Cl. B01J 33/00

(52) U.S. Cl. 502/1

(57) ABSTRACT

Urine-absorbing compositions comprising a liquid-absorbing solid absorbent and an organopolysiloxane betain ester of a fragrance alcohol selectively release the fragrance alcohol upon contact with urine. The urine-absorbing compositions are useful for animal litter and disposable sanitary products to mask urine scents.

### FIELD OF THE INVENTION

The invention provides urine-absorbing compositions from which a fragrance alcohol is released upon use.

### BACKGROUND OF THE INVENTION

A variety of consumer products, such as pet litters or disposable hygiene products, require a urine-absorbing material for their proper function. One problem with such urine-absorbing materials is the unpleasant and often offensive smell of the material after urine has been absorbed, which occurs, no matter how efficient the material absorbs urine. One possibility to counter the unpleasant smell of the used urine-absorbing material is to add a fragrance in order to mask the unpleasant smell and provide an overall smell that is less offensive.

However, simply adding a fragrance to a urine-absorbing material has the disadvantage that a substantial part of the fragrance is released from the material before it is actually used and the fragrance is needed. As a consequence, a rather large amount of fragrance has to be added to the material to ensure that an amount of fragrance sufficient for masking the urine smell is still present at the time of use. Such a large initial amount of fragrance is not only costly, but may also result in an initial intensity of the fragrance scent, that in itself is offending.

Therefore, a number of attempts have been made to provide urine-absorbing compositions that release a urine-masking fragrance upon use.

U.S. Pat. No. 3,675,625 discloses an animal litter comprising a heat treated high density absorbent and a highly polar fragrant agent. The fragrant material is absorbed by the heat treated absorbent and is selectively desorbed upon contact with moisture. This principle of action limits the choice of fragrant materials to highly polar compounds and has the disadvantage, that fragrance may be released unintentionally by moisture absorbed from a humid surrounding.

U.S. Pat. No. 3,921,581 discloses moisture sensitive fragrance releasing particles composed of a fragrance adsorbed onto a powdered solid excipient and a binder and water sensitive disintegrant. These particles may be used as a pet litter additive. This principle of action may also result in an unintentional release of fragrance by moisture absorbed from a humid surrounding.

WO 2006/105680 discloses solid compositions comprising an absorbent material and a fragrance delivery vehicle. In the fragrance delivery vehicle, a core material is surrounded by microdroplets of a fragrance in a fragrance-encapsulating material. The compositions show an improved retention of fragrance in a humid surrounding, but require a rather complicated process for their manufacture.

US 2006/0185608 discloses breakable odor control additives for animal litter, which comprise a porous compressible substrate, saturated with a fragrance and coated with a breakable barrier coating, that prevents absorption of urine. This principle of action has the disadvantage, that fragrance may be released unintentionally by mechanical force upon handling the material, whereas no fragrance will be released when urine is absorbed without applying a force.

There remains a need for urine-absorbing compositions that release a urine-masking fragrance selectively upon contact with urine.

### SUMMARY OF THE INVENTION

The urine-absorbing compositions of the invention comprise a liquid-absorbing solid absorbent and an organopolysiloxane, which comprises at least one functional group Z having the structure

—N⁺R¹R²—CH₂—C(O)OY A⁻

wherein

R¹, R² are selected independently of each other from C₁₋₃₀ alkyl and hydroxyethyl,

Y is the radical of a fragrance alcohol Y—OH and

A⁻ is the anion of a physiologically compatible acid HA.

The urine-absorbing compositions of the invention have a low initial scent and do not release the fragrance alcohol Y—OH during storage, because the fragrance alcohol is chemically bonded to the high molecular, non-volatile organopolysiloxane. Upon contact with urine, the fragrance alcohol is released form the urine-absorbing compositions by acid-catalyzed hydrolysis of the betain functional groups Z carrying the radical of the fragrance alcohol. This release of the fragrance alcohol from the betain functional groups occurs selectively upon contact with the acidic urine, whereas the betain functional groups are much more stable against hydrolysis at a neutral pH and do not release fragrance alcohol with moisture from a humid surrounding.

The urine-absorbing compositions of the invention can be used in consumer products, such as pet litters or disposable hygiene products.

### DETAILED DESCRIPTION OF THE INVENTION

The urine-absorbing compositions of the invention comprise a liquid-absorbing solid absorbent and an organopolysiloxane.

Any solid absorbent that is capable of absorbing urine can be used as the liquid-absorbing solid absorbent, i.e. any solid that takes up both the water and the dissolved substances of urine.

Preferably, the liquid-absorbing solid absorbent is selected from layered silicates, cellulose, acrylic acid polymers and mixtures thereof. Suitable layered silicates are sepiolite, illite and clay minerals, such as kaolinite, bentonite, montmorillonite or vermiculite. The layered silicates may further be exfoliated and/or calcined. Suitable cellulose absorbents are cellulose fibers and cellulose rich materials, such as wood chips and sawdust, wheat fibers and straw chips, ground corn cobs and husks or cereal grain hulls. Suitable acrylic acid polymers are water-insoluble, swellable cross-linked acrylic acid polymers known as superabsorbent polymers.

Further suitable inorganic absorbents are diatomeceous earth, precipitated silica, expanded perlite and fly ash. Further suitable organic absorbents are polyurethane foams.

The urine-absorbing compositions of the invention further comprise an organopolysiloxane comprising at least one functional group Z having the structure

—N⁺R¹R²—CH₂—C(O)OY A⁻

wherein

R¹, R² are selected independently of each other from C₁₋₃₀ alkyl and hydroxyethyl,

Y is the radical of a fragrance alcohol Y—OH and

A⁻ is the anion of a physiologically compatible acid HA.

Organopolysiloxanes within the meaning of the invention are compounds containing at least three silicon atoms, which are bonded together by means of Si—O—Si units and in which more than half of the silicon atoms carry at least one radical bonded to the silicon atom by a carbon atom. The organopolysiloxanes according to the invention preferably contain from 3 to 200 and particularly preferably from 5 to 100 silicon atoms. In the organopolysiloxanes according to the invention, preferably more than 50% of the silicon atoms have two radicals bonded to the silicon atom by carbon atoms and particularly preferably more than 80%. The radicals bonded to silicon atoms by carbon atoms can be C₁₋₃₀ alkyl radicals, C₂₋₃₀ alkenyl radicals or C₆₋₃₀ aryl radicals, which can carry further substituents. The radicals bonded to silicon atoms by carbon atoms are preferably methyl groups or phenyl groups and particularly preferably methyl groups.

The betaine ester group Z having the structure

—N⁺R¹R²—CH₂—C(O)OY A⁻

is covalently bonded to the polysiloxane.

In a preferred embodiment of the invention, the betaine ester groups are coupled to silicon atoms of the organopolysiloxane via hydroxyethylene bridges and the organopolysiloxane has the structure

R³R⁴R⁵Si—O—CH₂—CH₂—N⁺R¹R²—CH₂—C(O)OY A⁻

wherein

R³ is a polysiloxane radical bonded by an oxygen atom,

R⁴ is a C₁₋₃₀ alkyl group or phenyl,

R⁵═R³ or R⁴ and

R¹, R², Y and A⁻ have the meaning cited above.

In a particularly preferred embodiment of the invention, betaine ester groups are bonded via hydroxyethylene bridges to the terminal silicon atoms of a polydimethyl siloxane having 2 to 300 silicon atoms. In this particularly preferred embodiment the organopolysiloxane has the structure

R⁶—O—[Si(CH₃)₂—O]ₙ—R⁶

wherein

n=3-200,

R⁶═—CH₂—CH₂—N⁺(CH₃)₂—CH₂—C(O)OY A⁻ and

Y and A⁻ have the meaning cited above.

Fragrance alcohols Y—OH within the meaning of the invention are fragrant compounds having a hydroxyl group bonded to a carbon atom, wherein no further atoms apart from hydrogen and carbon are bonded to this carbon atom. The organopolysiloxanes according to the invention preferably contain radicals Y of fragrance alcohols Y—OH used as constituents of perfume preparations.

The organopolysiloxanes particularly preferably contain radicals Y of fragrance alcohols Y—OH selected from the series comprising 4-allyl-2-methoxyphenol (eugenol), 3-(2-bornyloxy)-2-methyl-1-propanol, 2-tert-butylcyclohexanol, 4-tert-butylcyclohexanol, benzyl alcohol, 1-decanol, 9-decen-1-ol, dihydroterpineol, 2,4-dimethyl-4-cyclohexen-1-yl methanol, 2,4-dimethylcyclohexyl methanol, 2,6-dimethyl-2-heptanol, 2,6-dimethyl-4-heptanol, 3a,4,5,6,7,7a-hexahydro-2,4-dimethyl-4,7-methano[1H]inden-5-ol, 3,7-dimethyl-1,6-nonadien-3-ol, 2,6-dimethyl-2,7-octadien-6-ol (linalool), cis-3,7-dimethyl-2,6-octadien-1-ol (nerol), trans-3,7-dimethyl-2,6-octadien-1-ol (geraniol), 3,7-dimethyl-1,7-octanediol, 3,7-dimethyl-1-octanol (tetrahydrogeraniol), 2,6-dimethyl-2-octanol (tetrahydromyrcenol), 3,7-dimethyl-3-octanol (tetrahydrolinalool), 2,6-dimethyl-7-octen-2-ol (dihydromyrcenol), 3,7-dimethyl-6-octen-1-ol (citronellol), 2,2-dimethyl-3-(3-methylphenyl)-1-propanol, 2,2-dimethyl-3-phenyl-1-propanol, 2-ethoxy-4-methoxymethylphenol, 2-ethyl-4-(2,2,3-trimethyl-3-cyclopenten-1-yl)-2-buten-1-ol, cis-3-hexen-1-ol, 4-(4-hydroxy-3-methoxyphenyl)-2-butanone, 1-hydroxy-2-(1-methyl-1-hydroxyethyl)-5-methylcyclohexane, 3-(hydroxymethyl)-2-nonanone, 4-(4-hydroxy-4-methylpentyl)-3-cyclohexene-1-carboxaldehyde, isoborneol, 3-isocamphylcyclohexanol, 2-isopropenyl-5-methylcyclohexanol (isopulegol), 1-isopropyl-4-methylcyclohex-3-enol (terpinenol), 4-isopropylcyclohexanol, 1-(4-isopropylcyclohexyl) ethanol, 4-isopropylcyclohexylmethanol, 2-isopropyl-5-methylcyclohexanol (menthol), 2-isopropyl-5-methylphenol (thymol), 5-isopropyl-2-methylphenol (carvacrol), 2-(4-methyl-3-cyclohexenyl)-2-propanol (terpineol), 2-(4-methylcyclohexyl)-2-propanol (dihydroterpineol), 4-methoxybenzyl alcohol, 2-methoxy-4-methylphenol, 3-methoxy-5-methylphenol, 1-methoxy-4-propenylbenzene (anethol), 2-methoxy-4-propenylphenol (isoeugenol), 4-methyl-3-decen-5-ol, 2-methyl-6-methylene-7-octen-2-ol (myrcenol), 3-methyl-4-phenyl-2-butanol, 2-(2-methylphenyl) ethanol, 2-methyl-4-phenyl-1-pentanol, 3-methyl-5-phenyl-1-pentanol, 2-methyl-1-phenyl-2-propanol, (1-methyl-2-(1,2,2-trimethylbicyclo[3.1.0]hex-3-ylmethyl) cyclopropyl) methanol, 3-methyl-4-(2,2,6-trimethylcyclohexen-1-yl)-2-butanol, 2-methyl-4-(2,2,3-trimethyl-3-cyclopenten-1-yl)-2-buten-1-ol, (3-methyl-1-(2,2,3-trimethyl-3-cyclopentenyl)-3-cyclohexen-1-yl) methanol, 3-methyl-5-(2,2,3-trimethyl-3-cyclopenten-1-yl)-4-penten-2-ol, 2-methyl-2-vinyl-5-(1-hydroxy-1-methylethyl) tetrahydrofuran, trans,cis-2,6-nonadienol, 1-nonanol, nopol, 1,2,3,4,4a,5,6,7-octahydro-2,5,5-trimethyl-2-naphthol, 1-octanol, 3,4,5,6,6-pentamethyl-2-heptanol, 2-phenylethanol, 2-phenylpropanol, 3-phenylpropanol (hydrocinnamic alcohol), 3-phenyl-2-propen-1-ol (cinnamic alcohol), 4-(5,5,6-trimethylbicyclo[2.2.1]hept-2-yl) cyclohexan-1-ol, 3,5,5-trimethylcyclohexanol, 2,4,6-trimethyl-4-cyclohexen-1-ylmethanol, 5-(2,2,3-trimethyl-3-cyclopentenyl)-3-methylpentan-2-ol, 3,7,11-trimethyl-2,6,10-dodecatrien-1-ol (farnesol), 3,7,11-trimethyl-1,6,10-dodecatrien-3-ol (nerolidol), 3,5,5-trimethyl-1-hexanol (isononanol), 1-undecanol, 10-undecen-1-ol and vetiverol.

Anions A⁻ of physiologically compatible acids HA within the meaning of the invention are anions having no caustic or markedly irritating effect on human or animal skin. The anions A⁻ are preferably chosen from the series comprising chloride, bromide, methyl sulfate, ethyl sulfate, sulfate, nitrate, phosphate or hydrogen phosphate.

The organopolysiloxanes comprised in the compositions of the invention can be prepared by reacting organopolysiloxanes containing a tertiary amino group with a chloroacetic acid ester of a fragrance alcohol. Chloroacetic acid esters of fragrance alcohols can be obtained by known means by reacting chloroacetic acid chloride with a fragrance alcohol, the reaction preferably being performed in the presence of a base which binds the hydrogen chloride released in the reaction.

Organopolysiloxanes containing a tertiary amino group are obtainable through a series of known methods. A general way of producing these compounds is by reacting a secondary amine with an organopolysiloxane containing a suitable leaving group in a nucleophilic substitution reaction. A special embodiment of this reaction is the reaction of an organopolysiloxane containing a radical having an epoxide grouping with a secondary amine, with ring opening of the epoxide and formation of a beta-amino alcohol.

The preferred organopolysiloxanes, in which the betaine ester groups are coupled to silicon atoms of the organopolysiloxane via hydroxyethylene bridges, can be obtained by reacting an organopolysiloxane comprising at least one Si—H group with an ethanolamine having the structure HO—CH₂—CH₂—NR¹R², with subsequent reaction with a chloroacetic acid ester of a fragrance alcohol, wherein R¹ to R⁵ have the previously cited meaning:

R³R⁴R⁵Si—H+HO—CH₂—CH₂—NR¹R²→R³R⁴R⁵Si—O—CH₂—CH₂—NR¹R²

R³R⁴R⁵Si—O—CH₂—CH₂—NR¹R²+ClCH₂—C(O)OY→R³R⁴R⁵Si—O—CH₂—CH₂—N⁺R¹R²—CH₂—C(O)OY Cl⁻

In a preferred embodiment of the urine-absorbing compositions according to the invention the organopolysiloxane is absorbed in the liquid-absorbing solid absorbent.

The urine-absorbing composition of the invention can be prepared by mixing a liquid-absorbing solid absorbent and an organopolysiloxane of the structure defined above. Preferably, a solution of the organpolysiloxan in a solvent or an aqueous dispersion of the organpolysiloxan is sprayed onto the solid absorbent and the solvent or water employed is evaporated. Prefered solvents are alcohols, in particular ethanol and isopropanol. The spraying is preferably performed in a mixer, such as a plough mixer, or in a fluidized bed.

The urine-absorbing composition of the invention can be used in animal litters, preferably in pet litters for use within a household, such as cat litters. For use in animal litters, the urine-absorbing composition is preferably in the form of granules. Preferably, the median particle diameter, based on particle weight, of the granules is within the range of 0.1 to 10 mm, more preferably 0.5 to 5 mm.

The animal litter preferably has clumping properties in that the granules agglomerate upon contact with an aqueous liquid. Such desirable clumping properties can be achieved by selecting a clay mineral as the absorbent, which has such clumping properties per se. Alternatively, agglomerating agents may be added to the absorbent to provide the desired clumping properties, such as cellulose ethers, starches or vegetable gums. Preferably, galactomannan gums, such as guar gum, are used as agglomerating agents.

The animal litter may further comprise additives to inhibit the formation of odors, preferably selected from transition metal salts, urease inhibitors, antimicrobial biocides, bacteriostatic compounds and mixtures thereof. Suitable transition metal salts, urease inhibitors and antimicrobial additives are known from the prior art, in particular from U.S. Pat. No. 6,287,550 columns 5 to 12, which is incorporated herein by reference.

The animal litter may also comprise odor absorbing additives, preferably selected from zeolites, activated carbons, cyclodextrins and mixtures thereof. Suitable zeolites and cyclodextrins are known from the prior art, in particular from U.S. Pat. No. 6,287,550 columns 12 to 16, which is incorporated herein by reference.

The urine-absorbing composition of the invention can also be used in disposable sanitary product, preferably in diapers, adult incontinence garments or pantiliners. For use as a disposable sanitary product, the urine-absorbing composition is arranged within an at least partially water-permeable enclosure. The urine-absorbing composition is preferably arranged as a layer between a water-permeable topsheet and a water-impermeable backing sheet. Suitable topsheet materials and backing sheet materials are known from the prior art, in particular from WO 91/12031 pages 18 to 25, which is incorporated herein by reference.

For use in disposable sanitary product, the urine-absorbing composition preferably comprises an acrylic acid polymer as liquid-absorbing solid absorbent.

### EXAMPLES

### Example 1

Preparation of an organopolysiloxane having the structure

R⁶—O—[Si(CH₃)₂—O]ₙ—R⁶

where n=10, R⁶═—CH₂—CH₂—N⁺(CH₃)₂—CH₂—C(O)OY Cl⁻ and YOH=citronellol.

A mixture of 346 g (0.4 mol) of alpha, omega-bis-(2-dimethylaminoethoxy)poly(dimethylsiloxane) having an average molecular weight of 865 g/mol and 163 g (0.7 mol) of chloroacetic acid citronellyl ester was heated for 11 h to 60° C. The product obtained had a content of free chloride of 4.43 wt. % and a content of organically bonded chloride of 0.05 wt. %, giving a conversion to betaine ester of 99%.

### Example 2

5 g of the organopolysiloxane of example 1 were dissolved in 200 ml ethanol. The solution was sprayed onto 2 kg of commercial Catsan Ultra cat litter with permanent mixing of the cat litter and dried for 16 h under vacuum at room temperature. The resulting cat litter was odorless.

The resulting modified cat litter was mixed with an equal weight of unmodified Catsan Ultra cat litter and the mixture was treated with an aqueous buffer solution of pH 4, a pH value corresponding to the pH of cat urine. After treatment of the litter with such liquid, the lemony scent of citronellol was clearly discernable.

What is claimed is:

1. A urine-absorbing composition comprising
a) a liquid-absorbing solid absorbent and
b) an organopolysiloxane comprising at least one functional group Z having the structure
—N⁺R¹R²—CH₂—C(O)OY A⁻
wherein
R¹, R² are selected independently of each other from C₁₋₃₀ alkyl and hydroxyethyl,
Y is the radical of a fragrance alcohol Y—OH and
A⁻ is the anion of a physiologically compatible acid HA.

2. A urine-absorbing composition according to claim 1, wherein said liquid-absorbing solid absorbent is selected from the group comprising layered silicates, cellulose, acrylic acid polymers and mixtures thereof.

3. A urine-absorbing composition according to claim 1, wherein said organopolysiloxane is absorbed in said liquid-absorbing solid absorbent.

4. A urine-absorbing composition according to claim 1, wherein said organopolysiloxane has a structure according to formula (I)
R³R⁴R⁵Si—O—CH₂—CH₂-Z (I)
wherein
R³ is a polysiloxane radical bonded by an oxygen atom,
R⁴ is a C₁₋₃₀ alkyl group or phenyl,
R⁵═R³ or R⁴ and
Z has the same meaning as in claim 1.

5. A urine-absorbing composition according to claim 1, wherein said organopolysiloxane has a structure according to formula (II)
R⁶—O—[Si(CH₃)₂—O]ₙ—R⁶ (II)
wherein
n=3-200,
R⁶═—CH₂—CH₂—N⁺(CH₃)₂—CH₂—C(O)OY A⁻ and
Y and A⁻ have the same meaning as in claim 1.

6. A urine-absorbing composition according to claim 1, wherein said fragrance alcohol Y—OH is selected from the group comprising 4-allyl-2-methoxyphenol (eugenol), 3-(2-bornyloxy)-2-methyl-1-propanol, 2-tert-butylcyclohexanol, 4-tert-butylcyclohexanol, benzyl alcohol, 1-decanol, 9-decen-1-ol, dihydroterpineol, 2,4-dimethyl-4-cyclohexen-1-yl methanol, 2,4-dimethylcyclohexyl methanol, 2,6-dimethyl-2-heptanol, 2,6-dimethyl-4-heptanol, 3a,4,5,6,7,7a-hexahydro-2,4-dimethyl-4,7-methano[1H]inden-5-ol, 3,7-dimethyl-1,6-nonadien-3-ol, 2,6-dimethyl-2,7-octadien-6-ol (linalool), cis-3,7-dimethyl-2,6-octadien-1-ol (nerol), trans-3,7-dimethyl-2,6-octadien-1-ol (geraniol), 3,7-dimethyl-1,7-octanediol, 3,7-dimethyl-1-octanol (tetrahydrogeraniol), 2,6-dimethyl-2-octanol (tetrahydromyrcenol), 3,7-dimethyl-3-octanol (tetrahydrolinalool), 2,6-dimethyl-7-octen-2-ol (dihydromyrcenol), 3,7-dimethyl-6-octen-1-ol (citronellol), 2,2-dimethyl-3-(3-methylphenyl)-1-propanol, 2,2-dimethyl-3-phenyl-1-propanol, 2-ethoxy-4-methoxymethylphenol, 2-ethyl-4-(2,2,3-trimethyl-3-cyclopenten-1-yl)-2-buten-1-ol, cis-3-hexen-1-ol, 4-(4-hydroxy-3-methoxyphenyl)-2-butanone, 1-hydroxy-2-(1-methyl-1-hydroxyethyl)-5-methylcyclohexane, 3-(hydroxymethyl)-2-nonanone, 4-(4-hydroxy-4-methylpentyl)-3-cyclohexene-1-carboxaldehyde, isoborneol, 3-isocamphylcyclohexanol, 2-isopropenyl-5-methylcyclohexanol (isopulegol), 1-isopropyl-4-methylcyclohex-3-enol (terpinenol), 4-isopropylcyclohexanol, 1-(4-isopropylcyclohexyl) ethanol, 4-isopropylcyclohexylmethanol, 2-isopropyl-5-methylcyclohexanol (menthol), 2-isopropyl-5-methylphenol (thymol), 5-isopropyl-2-methylphenol (carvacrol), 2-(4-methyl-3-cyclohexenyl)-2-propanol (terpineol), 2-(4-methylcyclohexyl)-2-propanol (dihydroterpineol), 4-methoxybenzyl alcohol, 2-methoxy-4-methylphenol, 3-methoxy-5-methylphenol, 1-methoxy-4-propenylbenzene (anethol), 2-methoxy-4-propenylphenol (isoeugenol), 4-methyl-3-decen-5-ol, 2-methyl-6-methylene-7-octen-2-ol (myrcenol), 3-methyl-4-phenyl-2-butanol, 2-(2-methylphenyl) ethanol, 2-methyl-4-phenyl-1-pentanol, 3-methyl-5-phenyl-1-pentanol, 2-methyl-1-phenyl-2-propanol, (1-methyl-2-(1,2,2-trimethylbicyclo[3.1.0]hex-3-ylmethyl) cyclopropyl) methanol, 3-methyl-4-(2,2,6-trimethylcyclohexen-1-yl)-2-butanol, 2-methyl-4-(2,2,3-trimethyl-3-cyclopenten-1-yl)-2-buten-1-ol, (3-methyl-1-(2,2,3-trimethyl-3-cyclopentenyl)-3-cyclohexen-1-yl) methanol, 3-methyl-5-(2,2,3-trimethyl-3-cyclopenten-1-yl)-4-penten-2-ol, 2-methyl-2-vinyl-5-(1-hydroxy-1-methylethyl) tetrahydrofuran, trans,cis-2,6-nonadienol, 1-nonanol, nopol, 1,2,3,4,4a,5,6,7-octahydro-2,5,5-trimethyl-2-naphthol, 1-octanol, 3,4,5,6,6-pentamethyl-2-heptanol, 2-phenylethanol, 2-phenylpropanol, 3-phenylpropanol (hydrocinnamic alcohol), 3-phenyl-2-propen-1-ol (cinnamic alcohol), 4-(5,5,6-trimethylbicyclo[2.2.1]hept-2-yl) cyclohexan-1-ol, 3,5,5-trimethylcyclohexanol, 2,4,6-trimethyl-4-cyclohexen-1-ylmethanol, 5-(2,2,3-trimethyl-3-cyclopentenyl)-3-methylpentan-2-ol, 3,7,11-trimethyl-2,6,10-dodecatrien-1-ol (farnesol), 3,7,11-trimethyl-1,6,10-dodecatrien-3-ol (nerolidol), 3,5,5-trimethyl-1-hexanol (isononanol), 1-undecanol, 10-undecen-1-ol, vetiverol.

7. A urine-absorbing composition according to claim 1 in the form of granules for use as an animal litter.

8. A urine-absorbing composition according to claim 1 arranged within an at least partially water-permeable enclosure for use as a disposable sanitary product.
